(19) United States
(12) Patent Application Publication
(10) Pub. No.: US 2011/0047629 A1
(43) Pub. Date: Feb. 24, 2011

(54) Method and Apparatus for Enhanced Age Verification and Activity Management of Internet Users

(76) Inventors: Ian Mitchell, Newport County, RI (US); James T. Feeley, Washington County, RI (US); Robert C. Angell, Kent County, RI (US)

Correspondence Address: RYAN, MASON & LEWIS, LLP, 1300 POST ROAD, SUITE 205, FAIRFIELD, CT, 06824, US

(21) Appl. No.: 12/918,584

(22) PCT Filed: Feb. 27, 2009
(86) PCT No.: PCT/US09/35488

§ 371 Date: Nov. 16, 2010

Related U.S. Application Data
(60) Provisional application No. 61/032,753, filed on Feb. 29, 2008.

(51) Int. Cl. G06F 21/00; G06Q 10/00

(52) U.S. Cl. 726/28; 705/317

(57) ABSTRACT

Methods and apparatus are provided for verifying the age of an online user. The age and identity of at least one primary user is verified and the primary user provides an age of at least one secondary user. Content requests from the secondary user to access content from at least one online content provider are granted if the primary user has authorized the secondary user to access the content. A content provider delivers content by receiving an identifier and a content request from a secondary user to access content; redirecting the secondary user to a third party age verification server; receiving an indication from the third party age verification server that the secondary user has been authorized by a primary user to access the content; and granting the content request if the primary user has authorized the secondary user to access the content.

### CROSS-REFERENCE TO RELATED APPLICATIONS

The present application claims the benefit of U.S. Provisional Patent Application Ser. No. 61/032,753, filed Feb. 29, 2008, incorporated by reference herein.

### FIELD OF THE INVENTION

The present invention relates to techniques for anonymous age verification, activity management, and activity monitoring of internet users within a family.

### BACKGROUND OF THE INVENTION

There are an ever-increasing number of children using the internet. As this number increases, no does the need to provide a safer Internet environment for children. Many web sites contain content that children should have little, if any, access. In addition, many web sites gather personal information, for marketing purposes, from the children visiting their site. In terms of outright access to adult oriented sites, visitors are typically required to select a button that indicates that they are of legal age to view the content. This is easily defeated, since there is no “face-to-face” transaction and children can press any button on the screen without age verification by the web site. Some sites may require credit card entry but this has been met with resistance from credit card companies since the card of a parent can get into the hands of children.

Legislation and guidelines have been implemented to govern, to some extent, children's internet experience, including COPPA (Children's Online Privacy Protection Act) and ESRB (Entertainment Software Rating Board). In terms of soliciting information from children, web sites that are COPPA/ESRB-compliant will request that children under the age of 13 provide the email address of their parents so that the web site may contact the parent via email prior to collecting the information from the child. Again, this is easily defeated by the child by indicating that he or she is older than 13 or by providing a counterfeit email address for their parent. Further, if a valid email address is used for the parent, then the parent can get emails from various web sites in a very disconnected manner, making it hard to manage and monitor their children's activities, especially across multiple web sites and over time.

A third difficulty in safeguarding the Internet environment for minors is the need for web sites to maintain information about the activities of a particular child at their web site. In addition, some individual web sites have attempted to provide age verification of a child by physically contacting the parent, such as a telephone call to the parent.

A need exists for a parental consent system (PCS) that addresses all of these challenges by offering a substantially more robust mechanism for a web site to accurately identify a child's age, by providing parents a single point of management of their children's activities at participating web sites, and by providing web sites with a mechanism for simplified compliance with applicable regulations and guidelines, as well as a consistent and reliable means of determining the activities that a child is allowed to engage in.

### SUMMARY OF THE INVENTION

Generally, methods and apparatus are provided for enhanced age verification and activity management of Internet users. An aspect of the invention provides a mechanism and a process for adults or other authorized individuals to electronically perform a one-time establishment of their age and identity and to further establish, in an anonymous manner, the age(s) of their children. Adults will establish individual age verification accounts (the Primary Account) for themselves and for each one of their children (the Secondary Accounts), if applicable. PCS-compliant sites would require visitors to enter their PCS account name and password before being allowed to enter the web sites or, more typically, before being allowed to perform certain activities at the web sites. The account name and password are gathered and verified by the PCS system which then returns an age indication of the user back to the requesting web site along with parameters that define their allowed activities.

An embodiment of the present invention includes an electronic interface between the PCS and a person who is legally considered to be an adult (or another authorized individual) and wishes to establish or register a PCS Primary Account. Based on currently accepted identity verification techniques, this interface may also require the involvement of a PCS Verifier. A PCS Verifier is generally a trained individual that is physically present at the time of the PCS Primary and Secondary Account creation. The role of the PCS Verifier would be to confirm the identity of the legal adult and initiate the creation of a PCS Primary Account. In one implementation, approved PCS Verifiers are established by PCS prior to being allowed to verify adults with the PCS system. The actual information used by the PCS Verifier to establish the identity of the legal adult may vary and would be a function of the available and acceptable technologies. Examples of information would include a driver's license or other photo ID card, proof of address in multiple forms, an in-person credit card transaction, verbal and confirmable queries (for example, at Town Hall using existing information).

The need of PCS Verifier involvement would require that Primary and Secondary Account creation occurs at locations established for this activity (such as schools, town halls, libraries, police departments, YMCAs and retail outlets). Physical or “face to face” interaction between the parent and the PCS Verifier is dependent on acceptable age verification technologies. Other possible PCS Verifiers could include school systems that already have prior applicable data regarding children and their parents. In such a scenario, the school would initially establish the Primary and Secondary accounts for the parent and children upon appropriate consent of the parent. Once the accounts are established, the parent can take ownership of the accounts to enable and maintain the accounts. Additional possible PCS Verifiers could include: 1) registration at retail outlets involving the activation of a PCS card (similar to a phone card) with a credit card and photo ID; or 2) banks that would provide a PCS on-line service to already known and verified customers that participate in electronic bunking—such access would be provided through the bank's on-line interface. Again, these are examples that are based upon possible and acceptable age verification techniques

Another embodiment of the present invention is a method of allowing the account creator, after establishing the Primary Account and the ages of the children, to modify the Primary and Secondary Accounts (children's accounts) associated with the Primary Account. The Secondary Accounts contain, for example, date-of-birth, account name, password, and allowed activities for the people under the Primary Account. The date of birth on any account typically cannot be changed.

A further embodiment of the present invention is a means of electronically storing and processing account information. This embodiment allows monitoring and maintenance of the Secondary Accounts by the Primary Account holder and allows secure queries by participating web sites to determine the date of birth and allowed activities of PCS account holders.

Among other benefits, the present invention provides a more reliable means of establishing the age of a person using the Internet and, in the case of children, doing so anonymously and with the direct involvement of the parent, legal guardian or another authorized individual. The PCS accounts provide a single point for the parents to define and monitor activities and provide a single point for web sites to determine the age of visitors that use their PCS username and password. In this manner, the centralized nature of the PCS provides protection across a plurality of web sites. In addition, the PCS provides a convenient and flexible mechanism for a parent to easily tailor the privileges and activity constraints for a child based on the current age and maturity of the child.

Also, this system will reduce the possibility of fraud by requiring such things as a credit/debit card, a current or prior physical presence transaction, or a positive ID, to complete the registration. The disclosed system further reduces the possibility of fraud by gathering information about the point of account creation, such as PCS Verifier ID and a date/time tag for the activity. The information about the point of account creation may identify, for example, an account creation site that is allowing the creation of an inordinate number of PCS accounts. Additionally, the location (e.g., country or state) of the account could be available to allow web sites to enforce country-specific age limits on certain web activities. The PCS system can also provide the ability for the primary account holder to specify the resident country of each secondary account under that primary account. Providing a single and consistent interface for web sites to gather allowable info/motion about their visitors will simplify the verification of their ESRB/COPA compliance.

### BRIEF DESCRIPTION OF DRAWINGS

The foregoing and other features and advantages of the present invention will be more fully understood from the following detailed description of illustrative embodiments, taken in conjunction with the accompanying drawings in which:

FIG. 1 is a block diagram of a Parental Consent System in accordance with an embodiment of the present invention.

FIG. 2 is a flow diagram representing the creation of a PCS Primary Account in accordance with an embodiment of the present invention.

FIG. 3 is a flow diagram representing the activation of a PCS Primary Account in accordance with an embodiment of the present invention.

FIG. 4 is a flow diagram illustrating the creation and management of a PCS Secondary Account in accordance with an embodiment of the present invention.

FIG. 5 is a flow diagram representing the queries into a PCS account from visited web sites in accordance with an embodiment of the present invention.

FIG. 6 is a flow diagram representing the registration of a web site as a PCS-compliant web site.

FIG. 7 illustrates a Primary Account and associated Secondary Accounts, as well as the relationship between the Secondary Accounts and any site-specific browsing permissions established for the Secondary Account by the Primary Account holder.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

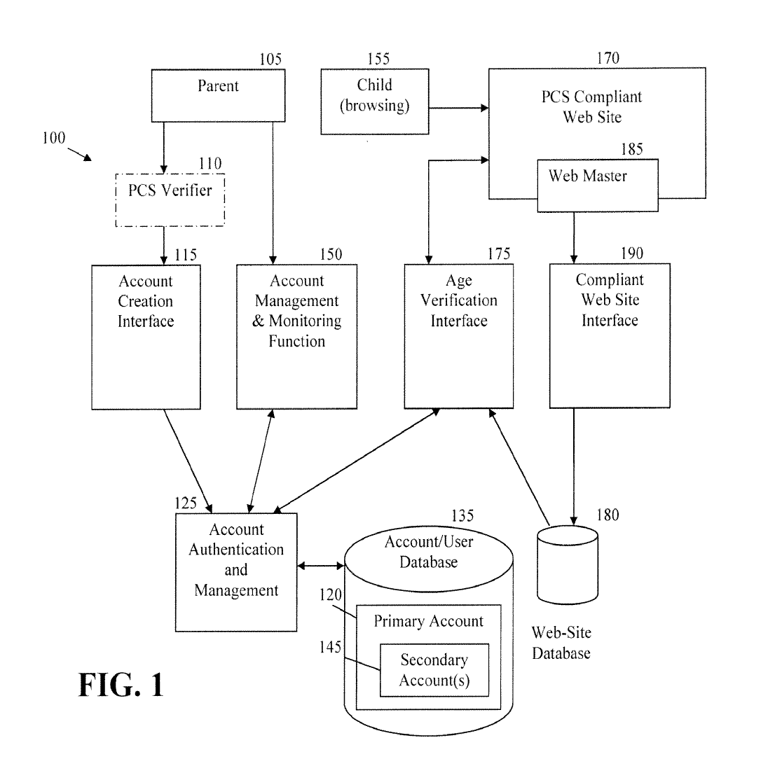

FIG. 1 is a block diagram of an exemplary Parental Consent System 100 in accordance with an embodiment of the present invention. As shown in FIG. 1, a Parent 105 interacts with an optional PCS Verifier 110 who in turn, is interfacing with an Account Creation Interface 115. The Parent 105 provides necessary identifying information for creating a Primary Account 120 to the PCS Verifier 110 who enters the identifying information via the Account Creation Interface 115. The received Primary Account 120 information is validated by the PCS Verifier 110 via the Account Authentication and Management Process 125. The Account Authentication and Management Process 125 also provides data encryption functionality to encrypt any accounts stored in an Account/User database 135. The Account Authentication and Management Process 125 communicates with the Account/User database 135 to retrieve or store account information.

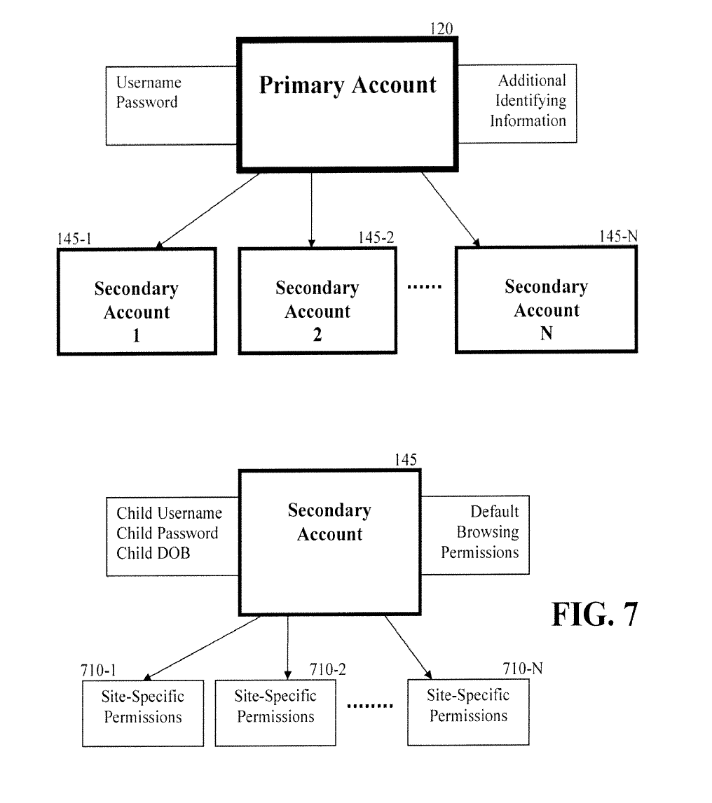

After establishing the Primary Account 120, the Parent 105 provides the date of birth information of each child 155 to the PCS Verifier 110. This data is also entered via the Account Creation Interface 115 to establish Secondary Accounts 145 and is processed similarly to the Primary Accounts 120. The Primary Account 120 and associated Secondary Accounts 145 are discussed further below in conjunction with FIG. 7. An Account Management and Monitoring Interface 150 additionally provides ongoing access to information for Primary Accounts 120 and Secondary Accounts 145 by the Parent 105. The Account Management and Monitoring Interface 150 also utilizes the Account Authentication and Management Process 125 to access, encrypt, and update data that is stored in the Account/User database 135.

While using the World Wide Web, a PCS user (typically a child with a Secondary Account 145) utilizes the Parental Consent System 100 by first accessing a PCS-enabled Web Site 170. A PCS-enabled Web Site 170 will redirect the user's web browser to an Age Verification Interface 175 when the website determines that the child is entering a protected area of the site. The Age Verification Interface 175 will access a Web-Site Database 180 to display a login prompt using an appearance established by each PCS-enabled web-site 170. The Age Verification Interface 175 will prompt the user for an account name and password. The Age Verification Interface 175 will access the Account/User Database 135 via the Account Authentication and Management Process 125 to retrieve the date of birth of the user. The Age Verification Interface 175 will also retrieve the allowed activities that have been established by the parent 105, either default activities or activities specific to the requesting web-site. The Age Verification Interface 175 will return control to the requesting PCS-enabled Web Site 170 along with the age and allowed activities of the user.

In order for a web-site to be PCS-compliant, the web site generally must register with the Parental Consent System 100 and establish a functional interface with the Parental Consent System 100, such as a Compliant Web Site Interface 190. Information specific to the web site is stored in the Web-Site Database 180.

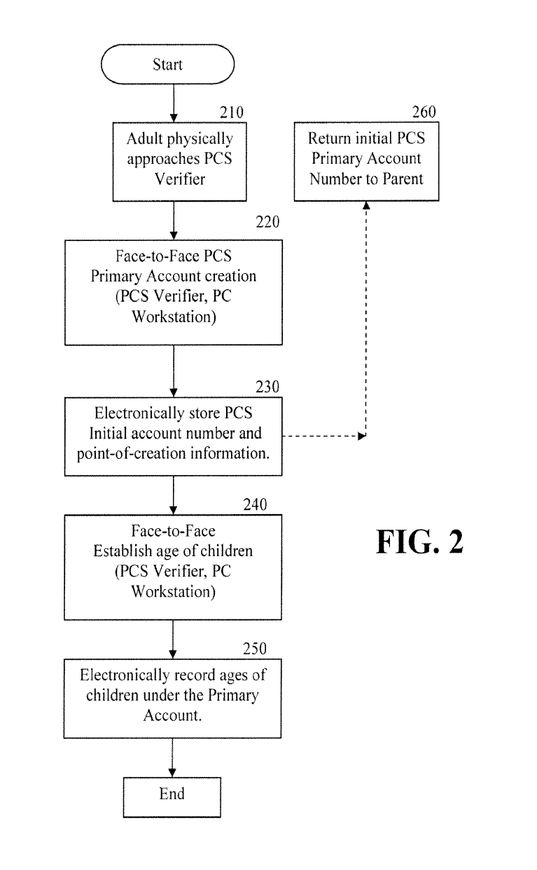

FIG. 2 is a flow diagram representing the exemplary creation of a Primary Account 120 in accordance with an embodiment of the present invention. The exemplary process begins by an adult selecting and utilizing a participating PCS Verifier 110 to confirm their age and identity during step 210. In the exemplary embodiment, a face-to-face example of a PCS Verifier 110 is employed during step 220. Other types of age and identity verification that are deemed to be appropriate may also be employed, as would be apparent to a person of ordinary skill in the art. Establishing an account with the face-to-face method requires that the PCS Verifier 110 has a PC with a web connection to access the account creation interface 110 that allows the creation of Primary Accounts 120. The Parental Consent System 100 will electronically store an initial and temporary Primary Account 120 during step 230. Once the temporary Primary Account 120 has been established, the parent 105 specifies the ages of the children that are to have Secondary Accounts 145 during step 240. This also takes place through the PCS Verifier 110 and is stored during step 250. The newly-registered adult will be given a name for the Primary Account 120 during step 260 to later sign on and create a permanent Primary Account 120. The initial Primary Account 120 can have an expiration date for security reasons. It is again noted that there could be other types of age verifying techniques and supporting technologies and processing other than the example discussed herein.

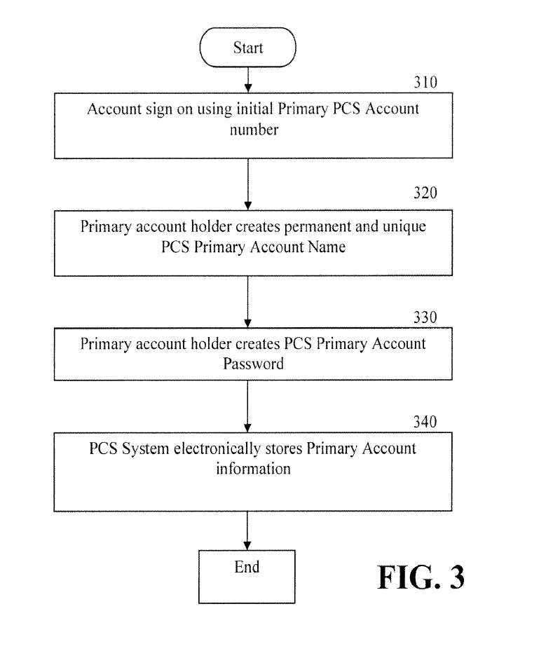

FIG. 3 is a flow diagram representing the exemplary activation of a Primary Account 120 in accordance with an embodiment of the present invention. This occurs after Account Creation (FIG. 2) and typically without the presence of the PCS Verifier 110. After creating an initial Primary Account 120, the adult signs into PCS during step 310 with the initial account name. Once signed in, the adult is required to create the permanent Primary Account 120 with a new account name and password during steps 320 and 330, respectively. The entered information for the Primary Account 120 is stored during step 340.

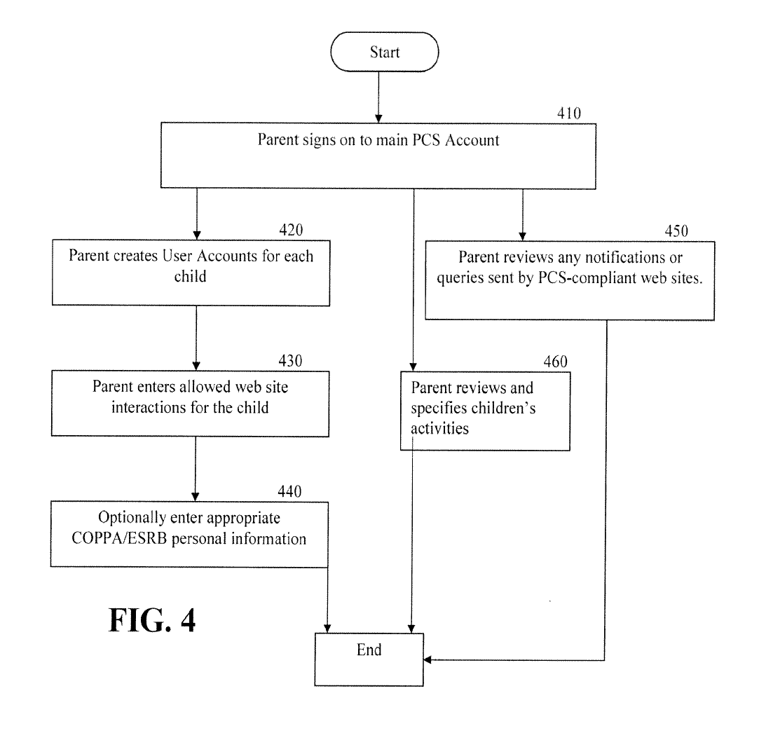

FIG. 4 is a flow diagram illustrating the exemplary creation and management of a Secondary Account 145 in accordance with an embodiment of the present invention. After establishing the permanent Primary Account 120 and the ages of the children associated with the account, the holder of the Primary Account 120 may then create other Secondary Accounts 145 that will be associated for each child. These Secondary Accounts 145 are electronically associated with the Primary Account 120. For each Secondary Account 145, the parent 105 will create a unique account name and password—the date of birth generally cannot be changed. All user account information is stored electronically in Parental Consent System 100. Parents 105 can establish default access parameters for each user under their account. Parents 105 can choose to let their children access compliant sites using these defaults or Parents 105 can request to be notified via email or via the PCS website when a child has requested access to protected areas of a PCS-enabled Web Site 170. A parent 105 may then choose to visit the requesting web site and then use the Parental Consent System 100 to specify the information that can be provided to that site as well as the allowed level of access to that site.

As shown in FIG. 4, the Parent 105 initially signs on during step 410 to the Primary Account 120. Thereafter, the Parent 105 creates user accounts for one or more children during step 420. The parent 105 enters the allowed web site interactions for the child during step 430 and optionally enters appropriate COPPA/ESRB personal information during step 440. The parent can review any notifications or queries sent by any PCS-compliant site 170 during step 450, and can review and specify activities of the child during step 460.

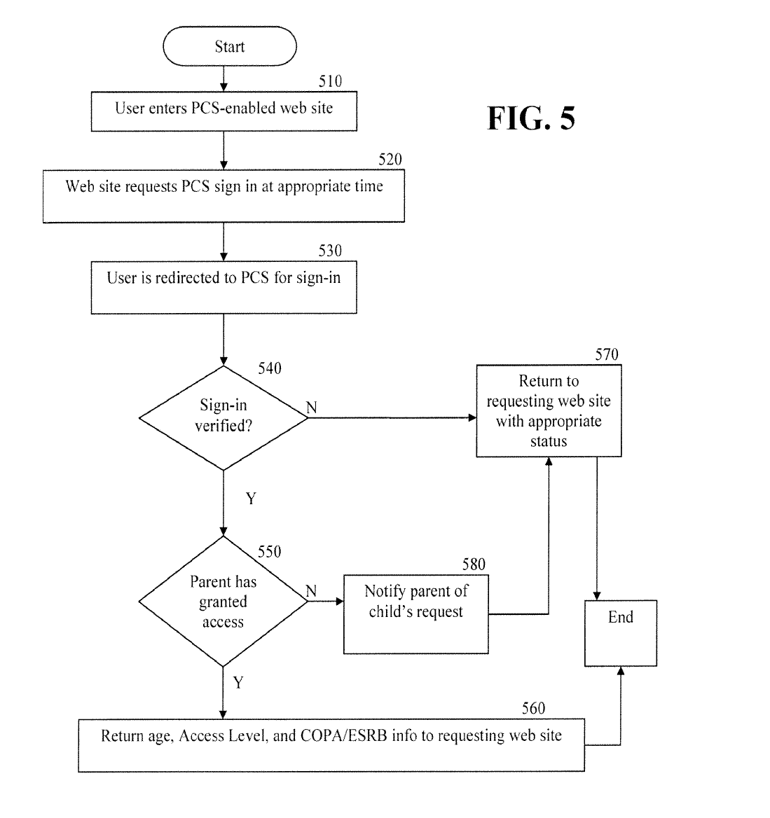

FIG. 5 is a flow diagram representing exemplary queries into an account from visited web sites in accordance with an embodiment of the present invention. Generally, the exemplary method anonymously confirms a user's age to a PCS-enabled Web Site 170. First, a user visits a PCS-enabled web site 170. When the child visits a protected area of the PCS-enabled website 170, the website will determine it is necessary to verify the user's age. The PCS-enabled Web Site 170 will redirect the user to the PCS web site, where the user will enter his/her username and password. The Parental Consent System 100 will retrieve the age of the user from the Account/User Database 135 and return it, and control back to the PCS-enabled Web Site 170. The PCS-enabled Web Site 170 will then use the age information to control what the user is able to do at that site.

As shown in FIG. 5, the user initially accesses the PCS-enabled website 170 during step 510. Thereafter, the PCS sign in is requested during step 520. The user is redirected to the Parental Consent System 100 during step 530. A test is performed during step 540 to determine if the sign-in was verified. If the sign-in is verified, a further test is performed during step 550 to determine if the Parent 105 has granted access for this user for this site. If the parent 105 has granted access, the age, access level, and COPPA/ESRB information is sent to the requesting web site during step 560.

If the sign-in is not verified during step 540, the appropriate status is returned to the requesting web site during step 570. If the parent has not granted access during step 550, the parent is notified of the request during step 580 and program control proceeds to step 570.

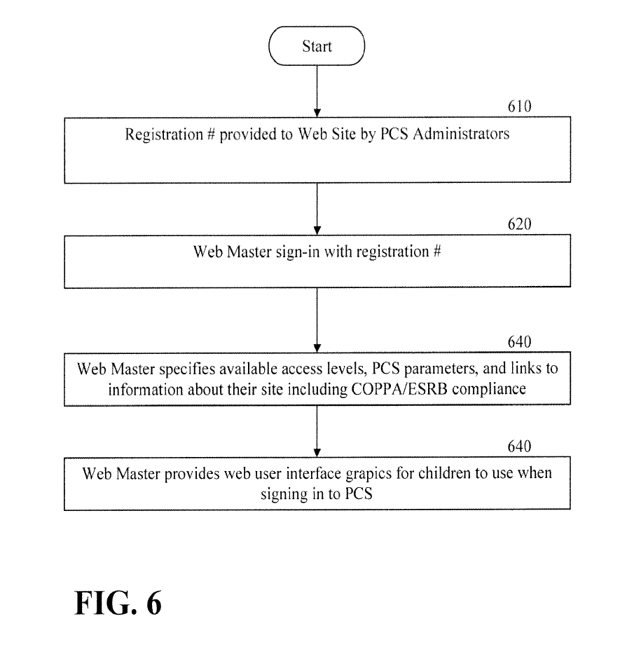

FIG. 6 is a flow diagram representing the exemplary registration of a web site as a PCS-enabled Web Site 170. Generally, the exemplary method allows PCS-enabled web sites 170 to establish their operation related to Parental Consent System 100. PCS-enabled web sites 170 use the PCS web site to provide information to parents 105 such as the level of PCS compliance, an overview of the web site, how child information would be used if received from the Parental Consent System 100, compliance with COPPA/ESRB, etc. PCS-enabled web sites 170 will also be able to provide information to the Parental Consent System 100 that describes the user interface a child would see to sign in to the Parental Consent System 100.

As shown in FIG. 6, a registration number is initially provided to the web site by administrators during step 610. Thereafter, the web master 185 can sign in using the registration number during step 620. The web master 185 then specifies, during step 630, available access levels, PCS parameters, and links to information about the site including COPPA/ESRB compliance. Finally, the web master 185 provides web user interface graphics for children to use when signing in to the site during step 640.

FIG. 7 illustrates a Primary Account 120 and associated Secondary Accounts 145, as well as the relationship between the Secondary Accounts 145 and any site-specific browsing permissions established for the Secondary Account 145 by the holder of the Primary Account 120. As shown in FIG. 7, an exemplary Primary Account 120 is created, for example, by a Parent 105 with one or more Secondary Accounts 145-1 through 145-N. The Secondary Accounts 145-1 through 145-N may be associated, for example, with the children of the parent 105. The exemplary Primary Account 120 typically has an associated Username, Password, and Additional Identifying Information. As further shown in FIG. 7, the exemplary Secondary Account 145 typically has an associated Child Username, Child Password, Child Date-of-Birth and any Default Browsing Permissions. In addition, the exemplary Secondary Account 145 may have Site-Specific Permissions established by the Primary Account 120 holder for one or more sites 710-1 through 710-N.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

While a number of the figures herein show an exemplary sequence of steps, it is also an embodiment of the present invention that the sequence may be varied. Various permutations of the algorithm are contemplated as alternate embodiments of the invention. While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for verifying the age of an online user, comprising:
verifying the age and identity of at least one primary user;
receiving an age of at least one secondary user from said primary user;
receiving a content request from said at least one secondary user to access content from at least one online content provider; and
granting said request from said at least one secondary user to access said content if said at least one primary user has authorized said at least one secondary user to access said content from said at least one online content provider.

2. The method of claim 1, further comprising the step of receiving one or more activities allowed for said at least one secondary user.

3. The method of claim 2, further comprising the step of receiving one or more modifications to said activities allowed for said at least one secondary user.

4. The method of claim 1, wherein said at least one secondary user is a child and said at least one primary user is an authorized adult.

5. The method of claim 1, wherein said verifying step further comprises the step of obtaining point-of-creation information for said verification.

6. The method of claim 1, further comprising the step of returning an account identifier to said at least one primary user.

7. The method of claim 1, further comprising the step of recording one or more activities of said at least one secondary user for subsequent evaluation by said primary user.

8. The method of claim 1, wherein said granting step further comprises the step of providing information about said at least one secondary user to said at least one online content provider for a compliance report.

9. The method of claim 1, further comprising the step of notifying said at least one primary user if said request from said at least one secondary user to access said at least one online content provider is not authorized by said at least one primary user.

10. The method of claim 1, wherein said verifying step is performed by an authorized verifier entity.

11. A method performed by at least one online content provider for delivering content to at least one online user, comprising:
receiving an identifier and a content request from at least one secondary user to access content, wherein said identifier identifies said at least one secondary user;
redirecting said at least one secondary user to a third party age verification server;
receiving an indication from said third party age verification server that said at least one secondary user has been authorized by at least one primary user to access said content from said at least one online content provider; and
granting said content request from said at least one secondary user to access said content if said at least one primary user has authorized said at least one secondary user to access said content from said at least one online content provider.

12. The method of claim 11, further comprising the step of evaluating one or more activities allowed for said at least one secondary user.

13. The method of claim 11, wherein said at least one secondary user is a child and said at least one primary user is an authorized adult.

14. The method of claim 11, further comprising the step of recording one or more activities of said at least one secondary user for subsequent evaluation by said primary user.

15. The method of claim 11, further comprising the step of receiving information about said at least one secondary user for a compliance report.

16. The method of claim 11, further comprising the step of notifying said at least one primary user if said request from said at least one secondary user to access said at least one online content provider is not authorized by said at least one primary user.

17. An apparatus for verifying the age of an online user, comprising:
a memory; and
at least one processor, coupled to the memory, operative to:
verify the age and identity of at least one primary user;
receive an age of at least one secondary user from said primary user;
receive a content request from said at least one secondary user to access content from at least one online content provider; and
grant said request from said at least one secondary user to access said content if said at least one primary user has authorized said at least one secondary user to access said content from said at least one online content provider.

18. An apparatus employed by at least one online content provider to deliver content to at least one online user, comprising:
a memory; and
at least one processor, coupled to the memory, operative to:
receive an identifier and a content request from at least one secondary user to access content, wherein said identifier identifies said at least one secondary user;
redirect said at least one secondary user to a third party age verification server;
receive an indication from said third party age verification server that said at least one secondary user has been authorized by at least one primary user to access said content from said at least one online content provider; and
grant said content request from said at least one secondary user to access said content if said at least one primary user has authorized said at least one secondary user to access said content from said at least one online content provider.
